(19) United States
(12) Patent Application Publication
(10) Pub. No.: US 2008/0284073 A1
(43) Pub. Date: Nov. 20, 2008

(54) VARIABLE SPEED GAS SPRING

(76) Inventor: Clare P. Heleski, Zeeland, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/749,279

(22) Filed: May 16, 2007

(51) Int. Cl. F16F 9/18

(52) U.S. Cl. 267/124

(57) ABSTRACT

A gas spring having a cylindrical housing has multiple regions through which a piston moves. A piston rod extends through one end of the cylindrical housing. One region is pressurized with an inert gas and at least a second region includes a multiple viscosity fluid, such that, as the piston moves under the influence of the pressurized gas, the piston rod moves at a variable speed. In one embodiment, the second region includes two layers of different viscosity oils with the oil adjacent the piston, having a lower viscosity and density than the second layer of oil. In other embodiments, the second region has a substantially continuously varying viscosity fluid.

### BACKGROUND OF THE INVENTION

The present invention relates to gas springs and particularly to a gas spring which has an extendable rod that moves at a variable speed during its stroke.

Gas springs are used in a variety of applications including the automotive environment in which hoods, trunks, and hatches frequently include gas springs for assisting in opening the relatively heavy members and preventing them from closing too rapidly. In other environments, such as office cabinets which frequently have somewhat heavy vertically pivoted doors, gas struts are again often used to assist in opening and closing such doors in a controlled fashion. Examples of gas springs which have been used for such applications are disclosed in U.S. Pat. Nos. 5,615,867; 6,053,486; 6,776,270; and 7,073,642.

In most applications, it is desired to allow a door to initially close or open relatively rapidly and, in a closing application, subsequently slow near the end of its closing motion to prevent the door from slamming shut. To accommodate such action, gas springs have in the past been formed with a cylinder having an internal tapered groove which communicates with the sealed piston associated with the gas spring and which groove narrows as the spring reaches its extended limit to thereby provide more resistance to the movement of the damping oil used past the piston and rod coupled thereto at the end of its stroke when the door is closing. This and other approaches have required somewhat complicated designs for the gas spring and/or additional parts to provide a variable speed effect.

Thus, there exists a need for a gas spring which is relatively inexpensive to manufacture and yet provides the performance characteristics of more expensive and complicated gas spring structures.

### SUMMARY OF THE INVENTION

The system of the present invention provides such a device by providing a gas spring having a cylindrical housing with a piston and piston rod extending from said piston and outwardly through one end of the housing. The cylinder includes a region pressurized with an inert gas and a region including a multiple viscosity fluid, such that the piston can move through both regions. As the piston moves under the influence of the pressurized gas, it moves through the multiple viscosity fluid. This results in the piston rod moving with respect to the housing at a variable slower speed. In one embodiment of the invention, two layers of different viscosity oils, with the oil adjacent the piston when raised having a lower viscosity and density than the second layer of oil, such that the piston will move more quickly through the first oil layer and subsequently be slowed significantly as it enters the second oil layer. The different densities of the fluids cause them to separate under the force of gravity when the gas spring is mounted in a generally vertical position. In another embodiment, the oil region includes a substantially continuously varying viscosity fluid. Thus, with the gas assist spring of the present invention, a relatively inexpensive gas spring includes a variable viscosity fluid to achieve the desired controlled slowing motion of the rod extending from the gas spring. The resultant structure provides the desired performance characteristics at a greatly reduced cost by employing reliable gas strut construction for durability.

These and other features, objects and advantages of the present invention will become apparent upon reading the following description thereof together with reference to the accompanying drawings.

### BRIEF DESCRIPTION OF THE DRAWINGS

FIG. 1 is a fragmentary, cross-sectional view of a cabinet having a vertically pivoted door which is controlled by a gas spring embodying the present invention;

FIG. 2 is a vertical cross-sectional view, partly broken away, of the gas spring shown in FIG. 1;

FIG. 3 is an enlarged cross-sectional view of a section of the piston of FIG. 2, shown encircled at III; and

FIG. 4 is an alternative embodiment of the gas spring shown in FIG. 2.

### DETAILED DESCRIPTION OF THE PREFERRED EMBODIMENT

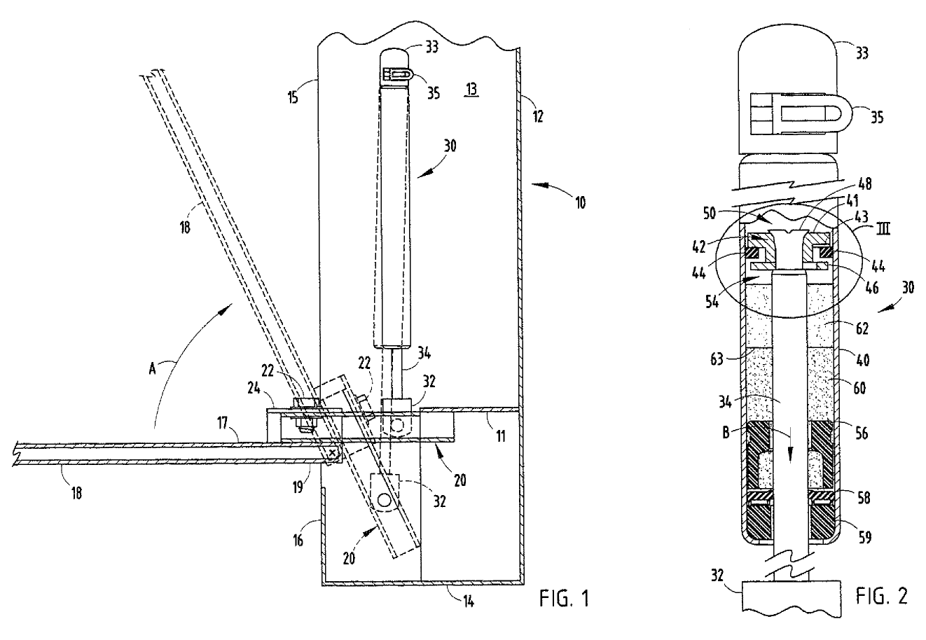

Referring initially to FIG. 1, there is shown a cabinet 10 which includes a gas spring 30 embodying the present invention. Although a cabinet 10 is shown, gas spring 30 can be employed in numerous environments, such as in the automotive, boating, aircraft or other environments, in which it is desired to control the motion of a movable element with respect to a fixed element with a controlled variable speed. The cabinet 10 of FIG. 1 includes a back wall 12, side walls 13 (one wall being shown), floor 14, a lower partial front fixed panel 16 and a vertically pivoted closure door 18. Door 18 is pivotally mounted between the side walls 13 by a conventional pivot connection represented schematically at 19 in FIG. 1. The door, thus, moves from a fully open horizontal position, as shown in solid lines in FIG. 1, toward a closed position, as shown in phantom lines in FIG. 1, during its closure motion as shown by arrow A in FIG. 1, to a position in which the door fully encloses the front 15 of the cabinet 10. Cabinet 10 also includes a top (not shown).

Attached to the inner surface 17 of door 18 by fasteners 22 and mounting block 24 is a fulcrum bar 20 which extends on the side of pivot axle 19 opposite door 18 and is pivotally coupled by a ball and socket coupling 32 to the end of extendable piston rod 34 of gas spring 30. The opposite end of gas spring 30 also includes a ball and socket pivot coupling member 33 which is pivotally coupled to the side wall 13. In some embodiments, each of the side walls may include a gas spring with the door 18 including a fulcrum bar 20 at each end. The pivot connections 32 and 33 may be of the type described in U.S. Pat. No. 7,124,864, the disclosure of which is incorporated herein, which includes a quick disconnect lever 35 for assisting in the ease of installation of the gas spring 30 to the cabinet 10.

The gas spring 30, as is well known in the design and application of such springs, is pressurized with a pressure selected for a given application. When the cover 18, for example, in the FIG. 1 application is fully opened (as shown in solid lines), the rod 34 is fully retracted within the spring 30 and the cover 18 is in a static state and held in a generally horizontal position in this particular application by a horizontal stop wall 11 in cabinet 10. The gas spring 30 is mounted to the cabinet 10 (and in other applications in other environments) in a generally vertical position and will remain in a generally vertical position throughout the range of motion of the movable object to which it is attached.

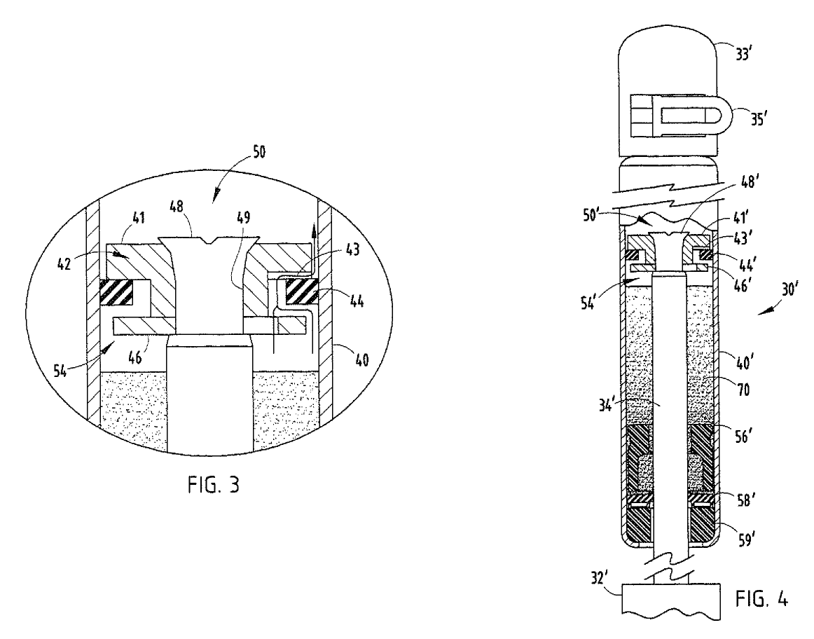

Gas spring 30 of the present invention is shown in detail in FIGS. 2 and 3 and includes a generally cylindrical housing 40 in which a piston assembly 42 is slideably mounted. The piston assembly includes a piston 41 having an annular recess 43 therein which receives a polymeric piston ring 44, typically made of polytetrafluoroethylene (PTFE). The ring 44 is backed by an open-flow washer 46. Piston assembly 42 is secured to the end of piston rod 34 by a suitable attachment, such as swaged end 48 of piston rod 34. End 48 extends through central aperture 49 in piston 41 and is swaged to hold piston 41 to the upper end of piston rod 34. The piston 41 includes a radially extending port 47 (best seen in FIG. 3) having a depth, in one embodiment, of approximately 0.5 mm to allow the passage of fluid therethrough, such that the piston and rod 34 attached thereto can move downwardly for closing door 18 by moving in the direction indicated by arrow B in FIG. 2.

Housing 40 includes an upper region 50 and a lower region 54 on a side of piston assembly 42 opposite region 50, as seen in FIG. 2. The piston rod 34 extends through region 54, which includes at its lower end an annular spacer 56 of conventional design, as well as a fluid seal 58 sealing the piston rod 34 within housing 40. A lower piston rod guide 59 on the opposite side of seal 58 guidably supports rod 34. The construction of such gas spring elements is conventional and such aspects of spring 30 can be of the type disclosed in U.S. Pat. No. 5,615,867, the disclosure of which is incorporated herein by reference.

Upper region 50 of gas spring 30 will typically be filled with a pressurized inert gas, such as nitrogen, and, depending upon the application and the desired actuating force for piston rod 34, the pressure can be varied anywhere from about 10 psi to about 250 psi, although pressures as high as 600 psi have been employed depending also upon the size of the spring 30. The lower region 54 of spring 30, however, is uniquely at least partially filled with multiple viscosity fluids, such as oil. In one embodiment shown in FIG. 2, the lower region 54 has a first higher viscosity oil 60 at the lower end which is remote from piston assembly 42 and a lower viscosity, less dense oil layer 62 immediately adjacent piston assembly 42. The use of multiple viscosity oils provides a controlled variable speed motion for the piston rod when closing the door 18, as seen in FIG. 1, by initially moving the cylinder rod and piston through the upper region 54 above the oil levels 60 and 62. Subsequently, piston assembly 42 engages the lower viscosity oil 62, which slows the extension of piston rod 34 somewhat. As the piston travels through the lower viscosity oil zone 62, the closing motion of door 18 slows significantly from its initial closing speed. As the piston enters the higher viscosity oil zone 60 toward the end of the travel of piston 34, the movement of piston rod 34 is greatly slowed to ease the closing of door 18 until such time as the piston reaches the lower stop at spacer 56. The spring 30 is mounted to wall 13 of cabinet 10 at a location which is selected to assure the full excursion of rod 34 and piston assembly 42 through the different viscosity fluids 60, 62 as the door 18 is fully closed.

The oils 62 and 60 separate under gravity due to their different, specific gravities and, in one embodiment the higher viscosity, higher density oil 60 was Mobil glygoyle 460 having a viscosity of 460 cSt at 40° C. with a specific gravity of 1.076 at 15° C. In this embodiment, the lower density and viscosity oil 62 was Univis N32 commercially available from Exxon Company, USA, which has a viscosity of 32 cSt at 42° C. and a specific gravity of 0.87 at 15.6° C. The differences in specific gravity result in the striation of the levels of oil 60 and 62, as shown by boundary 63 in FIG. 2, under the influence of gravity. Thus, when the gas spring 30 is mounted in a generally vertical orientation, as shown in the embodiment of FIG. 1, the piston assembly 42 is initially subjected to the lower viscosity fluid 62 and subsequently the higher viscosity, more damping fluid 60 as the piston 41 is forced downwardly under the gas pressure in region 50.

During the initial extension of piston rod 34 from spring 30, as seen in FIG. 2, the fluid in lower region 54 flows primarily through port 47. When piston rod 34 moves in the opposite or retracting direction when opening door 18, the sealing effect of ring 44 is diminished, allowing the piston assembly 42 and rod 34 to move quickly to the retracted position with significantly less influence by the fluid in lower region 54. The fluid 62, 60 moves around the washer 46 and through port 47 in piston 41 controlling the movement of piston assembly 42 and rod 34 coupled thereto as well as the movable member to which the gas spring is coupled for controlling the speed of movement of piston rod 34 in a variable manner as the piston assembly travels through the lower region 54 of gas spring 30.

The specific oils 60 and 62 in the example are merely illustrative and numerous other oils employed in gas springs and having different specific gravity and viscosity characteristics can be employed, it being important that the specific gravities and viscosities are different to provide the resulting controlled desired variable movement of the piston rod of the gas spring.

FIG. 4 shows an alternative embodiment of the invention in which the same parts as the FIGS. 1-3 embodiment are identified by the same reference numerals followed by a prime (′) symbol. In FIG. 4, the lower region 54′ of gas spring 30′ is filled with an oil 70 comprising either multiple fluids of different specific gravities and viscosities such that discreet but multiple striations of oil are formed from top to bottom in the lower region 54′ to provide a substantially continuously variable but slowing extension of piston rod 34′ from gas spring 30′ as opposed to a more discreet two-step slowing of the extension of piston rod 34 of FIGS. 1-3. Thus, for example, filling lower region 54′ with five or more oils of different and increasing specific gravities and viscosities will result in a substantially and effectively continuously variable viscosity fluid 70 as the piston assembly 42′ travels through the damping fluid to slow the progression of extension of piston rod 34′ from gas spring 30′. It is contemplated that continuously variable viscosity oils likewise could be employed.

Thus, with the gas strut of the present invention, a relatively inexpensively manufactured and reliable gas strut is provided with improved operational characteristics to allow the relatively quick initial movement of a movable member with respect to a fixed member between which the gas strut is mounted and subsequently progressively slower movement toward the end of travel of the moveable member with respect to the fixed member. This device can be applied in numerous applications in the automotive, furniture, and other fields to provide such desired control. As is also well known, a gas spring can be mounted in a configuration to control the movement of one member with respect to another in either direction (i.e., open or closed).

It will become apparent to those skilled in the art that these and various modifications to the preferred embodiments of the invention as described herein can be made without departing from the spirit or scope of the invention as defined by the appended claims.

The invention claimed is:

1. A variable speed gas spring comprising:
a housing including a piston and piston rod coupled to said piston and extending outwardly through one end of said housing, wherein said housing includes two regions;
a pressurized gas filling a first one of said regions; and
a variable viscosity fluid in a second one of said regions such that, as said piston moves under the influence of said pressurized gas through said variable viscosity fluid, said piston rod moves at a variable speed.

2. The spring as defined in claim 1 wherein said fluid in said second region comprises a liquid having multiple viscosity characteristics.

3. The spring as defined in claim 1 wherein said fluid in said second region comprises a plurality of liquids each having different viscosity characteristics.

4. The spring as defined in claim 3 wherein said fluid in said second region comprises two liquids, each with a viscosity different than the other liquid.

5. The spring as defined in claim 4 wherein the viscosity of one of the liquids adjacent said piston when said piston is in a first position is lower than the viscosity of said second liquid remote from said piston when in said first position.

6. The spring as defined in claim 5 wherein said two liquids are oil.

7. The spring as defined in claim 6 wherein one of said oils has a viscosity of about 32 cSt at 42° C. and the other of said oils has a viscosity of about 460 cSt at 40° C.

8. A variable speed gas spring comprising:
a cylindrical housing including a piston and piston rod coupled to said piston and extending outwardly through one end of said housing, wherein said piston extends through two regions in said housing;
a pressurized gas filling a first one of said regions; and
a multiple viscosity fluid in a second one of said regions such that as said piston moves through said second region said piston rod moves at a varying rate.

9. The spring as defined in claim 8 wherein said multiple viscosity fluid comprises at least two different viscosity oils.

10. The spring as defined in claim 9 wherein the viscosity the oil adjacent said piston when said piston is in a first position is lower than the viscosity of said oil remote from said piston when in said first position.

11. The spring as defined in claim 10 wherein the viscosity said oil adjacent said piston is about 32 cSt at 42° C. and the other of said oils has a viscosity of about 460 cSt at 40° C.

12. A variable speed gas spring mounted in generally vertical relationship between a fixed member and a movable member to vary the speed of movement between said fixed and movable members in a predetermined manner comprising:
a housing having a first end coupled to one of a fixed and movable member, said housing including a piston and piston rod coupled to said piston and extending outwardly through a second end of said housing opposite said first end, wherein said piston extends through two regions in said housing and said piston rod is coupled to the other of said fixed and movable members;
a pressurized gas filling a first one of said regions; and
a variable viscosity fluid in a second one of said regions such that as said piston moves through said second region said piston rod moves at a varying rate.

13. The spring as defined in claim 12 wherein said fluid in said second region comprises a plurality of liquids having different viscosities.

14. The spring as defined in claim 13 wherein said liquids have a viscosity which increases in a direction away from said piston.

15. The spring as defined in claim 14 wherein said liquids are oil.

16. The spring as defined in claim 15 wherein said second region includes layers of oil.

17. The spring as defined in claim 16 wherein one of said oils has a viscosity of about 32 cSt at 42° C. and the other of said oils has a viscosity of about 460 cSt at 40° C.

18. A variable speed gas spring comprising:
a housing including a piston and piston rod coupled to said piston and extending outwardly through one end of said housing, wherein said housing includes at least two regions; and
a variable viscosity fluid in one of said regions such that, as said piston moves through said variable viscosity fluid said piston rod moves at a variable speed.

19. The spring as defined in claim 18 wherein said fluid in said one region comprises a liquid having multiple viscosity characteristics.

20. The spring as defined in claim 19 wherein said fluid in said one region comprises a plurality of liquids each having different viscosity characteristics.

21. The spring as defined in claim 20 wherein the viscosity of one of the liquids adjacent said piston when said piston is in a first position is lower than the viscosity of said second liquid remote from said piston when in said first position.

22. The spring as defined in claim 21 wherein said two liquids are oil.

23. The spring as defined in claim 22 wherein one of said oils has a viscosity of about 32 cSt at 42° C. and the other of said oils has a viscosity of about 460 cSt at 40° C.
